(19) United States
(12) Patent Application Publication
(10) Pub. No.: US 2021/0362787 A1
(43) Pub. Date: Nov. 25, 2021

(54) BODYWORK PART COMPRISING A BACKLIT ZONE

(71) Applicant: COMPAGNIE PLASTIC OMNIUM SE, Lyon (FR)

(72) Inventors: Gilles MOULIN, Sainte-Julie (FR); Gérald ANDRE, Sainte-Julie (FR)

(73) Assignee: COMPAGNIE PLASTIC OMNIUM SE, Lyon (FR)

(21) Appl. No.: 17/324,699

(22) Filed: May 19, 2021

(30) Foreign Application Priority Data
May 20, 2020 (FR) FR2005307

(51) Int. Cl. B62D 29/04; B60R 19/03; B05D 1/32; B05D 3/06; B29C 45/00; C08J 7/04

(52) U.S. Cl. CPC B62D 29/04; B60R 19/03; B05D 1/322; B60Q 1/2619; B29C 45/0053; C08J 7/0427; B05D 3/06

(57) ABSTRACT

It is provided a bodywork part made of painted plastic material consisting of a single plastic material, and in one piece, comprising a first zone having a first thickness and a second zone having a second thickness, the first thickness being greater than the second thickness so that the second zone has a higher transmittance than that of the first zone.

### CROSS-REFERENCE TO RELATED APPLICATIONS

This application claims priority to the French Application No. FR2005307, filed 20 May 2020, now pending, the contents of which are hereby incorporated by reference.

The present disclosure relates to the field of the automotive industry, and more particularly to a motor vehicle bodywork part comprising a transparent or translucent element.

An element is described as transparent when it allows light to pass through in the visible domain. An element having a transmittance greater than 70% is considered to be transparent. An element is described as translucent when it allows light to pass through in the visible domain, but without making it possible to clearly distinguish the objects. An element having a transmittance between 50% and 70% is considered to be translucent and an element having a transmittance of 0% is considered to be opaque.

According to the disclosed embodiments, an “opaque element” is an opaque or semi-opaque element, having a transmittance of less than 5%, preferably equal to 0%.

The transmittance of a material is the fraction of the luminous flux passing through it. Thus, the transmittance represents the ratio of the light intensity transmitted by the material to the incident light intensity. This is an average value of the luminous flux profile of a material measured between 425 nm and 725 nm by a spectrophotometer, for example of the CL-500A Konica Minolta model.

Elements are known that are attached to a bodywork part having the particular aim of highlighting the style of a vehicle, such as a line or a shape in order to reinforce the image that the manufacturer wishes to associate with its vehicle model. There are for example chrome strips or rods placed on the edge of a part or an equipment item. In order to enhance the esthetic effect produced by these bodywork elements, it has been proposed to place a light source behind a transparent surface of the bodywork element.

For example, the chrome strips running along the side of the vehicle, the rocker panels, the brand emblem, the door handle trims, the mirror caps are these style items whose design is subject to special care by the designers of the vehicle. By extension, all the bodywork parts which are visible from the outside and which participate in the general appearance of the vehicle, such as an opening, a bumper, a grille, can also be considered to be bodywork elements.

Bodywork parts are known that result from molding plastic material, and on which a transparent element is attached in a housing provided for this purpose.

These transparent elements have the drawback of having to be perfectly adapted to the housing present in the bodywork part. In addition, the assembly of such optical elements on bodywork parts has the drawback of having assembly clearances and projections of lower visual quality than what is required for a motor vehicle. Finally, such attached elements create complexity in the management of the impermeability to liquids, such as water (rain, washing, etc.).

Another solution could be to make the bodywork part entirely from a transparent or translucent material, and cover the zones with paint which must be opaque, or conversely, to paint the entire part and scrape the zones which must be transparent/translucent. However, such a solution has drawbacks:
at the border of the opaque (painted) and transparent/translucent zones, a small amount of light passes over the first few millimeters of the painted zone, thus causing a “halo” effect which is not acceptable;
the amount of paint needed to make a zone of the bodywork part opaque may be large depending on the thickness of the fully translucent or transparent bodywork part; this gives rise to cost, cycle time and quality problems.

The object of the invention is in particular to address these drawbacks by proposing a bodywork part made of painted plastic material, comprising a solid transparent zone which is impermeable to fluids. The object of the invention is also a method of manufacturing a bodywork part made of painted plastic material comprising a transparent zone, the method being simple, efficient and inexpensive.

To this end, the invention relates to a bodywork part made of painted plastic material consisting of a single plastic material and comprising a first zone having a first thickness and a second zone having a second thickness, the first thickness being greater than the second thickness so that the second zone has a higher transmittance than that of the first zone.

The one-piece bodywork part is particularly solid and does not have any gaps or misalignments formed by the assembly of two parts, which can adversely affect the appearance and impermeability of the part. Indeed, the boundary is clear between an opaque zone and a translucent/transparent zone.

In addition, because the bodywork part is made in one piece, there is no assembly, and therefore fluid tightness (especially with respect to water) is total, without having to use additional means.

The second transparent zone is obtained by producing a thinned zone having a thickness less than that of the first zone. A single material can therefore be used to produce the bodywork part comprising zones having different appearances. This allows a manufacturing method which is compatible with the industrial means that are already known. No particular investment is therefore necessary.

In addition, the bodywork part comprising an opaque zone owing to the large material thickness makes it possible to limit the quantity of primer (during the painting line) to be applied to the part compared to a part which would be entirely translucent or transparent.

According to other optional features of the bodywork part, taken alone or in combination:
the first zone is opaque or semi-opaque and the second zone is transparent or translucent;
the material is chosen from: translucent natural polypropylene, cycloolefin copolymers (COC), polyethylene (PE), polyamide (PA), polycarbonate (PC), acrylonitrile butadiene styrene (ABS), mixture of polycarbonate (PC), polystyrene (PS), polymethyl methacrylate (PMMA), thermoplastic polyurethane (TPU) and polyester (PET/PETG). Indeed, by modifying the thickness of certain zones to obtain thinned parts with respect to the rest of the part, it is possible to choose a material which is translucent and not transparent in the first zone.
the material is a random polypropylene copolymer, such as Moplen RP340N®; the second zone has a thickness of between 0.5 and 2 mm, preferably substantially equal to 1.5 mm. When the bodywork part is made of Moplen RP340N, the thinned zones having a thickness within this range exhibits a better transmittance, which can reach up to 81% transmittance.
the first zone has a thickness of between 2.8 and 3.5 mm.

The object of the invention is also a motor vehicle comprising at least one bodywork part described above.

A further object of the invention is a method for manufacturing the bodywork part described above, comprising a molding step consisting in injecting the material into a mold to form the bodywork part and a step of painting at least on the first zone.

According to other optional features of the manufacturing method, taken alone or in combination:

the method uses an insert in the mold to obtain the second zone. Thus, it is possible to use the same machine to produce bodywork parts with or without a transparent zone, which makes it possible to diversify the types of parts produced with the same manufacturing means. It is not necessary to develop a specific injection system capable of generating different thicknesses, which is long and complex, and generally generates significant defects. This method is therefore more reliable. Furthermore, the difference in thickness is obtained at the very moment of injection, thus not requiring additional post-treatment tooling and avoiding adding time to produce the part with a locally reduced thickness. This method for obtaining a part having two different thicknesses is therefore simple and rapid.

the method comprises the following steps: masking the second zone; painting the entire bodywork part; removing the masking. The masking step makes it possible to paint the entire part with less precision, and therefore more quickly, while protecting the transparent zone from paint splashes.

the method comprises the following steps: painting the entire bodywork part; removing the paint located in the second zone using a laser beam. This method, known as “laser scraping,” makes it possible to obtain a very precise outline for the transparent zones. This alternative is particularly advantageous for producing unpainted zones with small dimensions or with complex shapes and outlines. This technique of removing material by laser scraping can also be used to obtain the second zone. It thus makes it possible if necessary to remove, at the same time and cleanly, material injected to form the second zone, and a coating of paint which completely covered the part, and which must highlight the outline of the second zone. This technique also makes it possible to obtain a controlled surface state to limit the roughness, which could reduce the transparency of the zone with reduced thickness.

the second zone is obtained by removing material from the bodywork part, in post-treatment of the injection of the part. The injection means are therefore very simple, without having to manage an insert in the mold to modify the thickness locally, which would complicate the maintenance of the injection press. Thus, the bodywork part is simple to manufacture using a single mold for different models. It is also possible to use the same machine to produce bodywork parts with or without a transparent zone, which makes it possible to diversify the types of parts produced with the same manufacturing means. It is not necessary to develop a specific injection system capable of generating different thicknesses, which is long and complex, and generally generates significant defects. This method is therefore more reliable. The post-treatment means for removing the material locally can be parallelized to allow production rates to be maintained. Indeed, the time to obtain the injected part can, for example, be twice as short as the treatment time to remove the material locally. In this case, having two post-treatment means makes it possible to obtain the parts at the same rate as the injection.

the painting step is prior to the material removal step. In this way, in a single material removal step, both the second zone and a precise outline of the transparent zones are obtained.

the material is removed by milling. This material removal technique makes it possible to obtain a clean cut and above all very quickly, and if necessary, allows cutting at the same time, also cleanly, for example a coating of paint which completely covered the part, and which must highlight the outline of the second zone.

a quantity of material is made to creep out of the region intended to form the second zone, in order to remove the material. In one embodiment, the creep is formed using a heating means, such as a heating punch or an ultrasonic punch. In this embodiment, the method comprises the following steps:

The bodywork part is placed on a support,

A heating means is placed near region intended to form the second zone or in the region intended to form the second zone so as to melt a quantity of material from the region intended to form the second zone,

The molten material is made to creep into the peripheral zone so as to obtain the second thickness.

Preferably, the heating means has a contact surface intended to come into contact with the second zone to melt a quantity of material and define the shape of the second zone by the creep of the material. It is therefore possible to carry out the heating and the creep by the same tool, which simplifies the manufacturing method. Furthermore, it will be understood that the second thickness is defined by the distance to be traveled by the heating means and the pressure between the heating means and the support.

the material is removed by means of a laser beam.

the paint is applied to the inner face of the bodywork part, which has zones with reduced thicknesses according to one of the above methods. Preferably the paint is partly transparent to light, in order to form a decorative effect of the “secret light” type, that is to say, a light diffused through a cover. Indeed, when a light illuminates the inner face, the light will pass through the bodywork part, revealing light patterns corresponding to zones of reduced thickness which have a much higher transmittance than zones with a greater thickness.

### BRIEF DESCRIPTION OF THE FIGURES

The various embodiments will be better understood on reading the description which follows, given solely by way of example and with reference to the appended drawings in which:

FIG. 1 is a perspective view of a motor vehicle comprising a bodywork part according to the invention;

FIG. 2 is a front view of the painted bodywork part showing transparent zones according to one example;

FIG. 3 is a schematic view of a step of a method for manufacturing the bodywork part of FIG. 2 according to one embodiment of the invention;

FIG. 4 is a schematic view of a step of a method for manufacturing the bodywork part of FIG. 2 according to another embodiment of the invention;

FIG. 5 is a schematic view of another step of the method for manufacturing the bodywork part of the embodiment illustrated in FIG. 4.

### DETAILED DESCRIPTION

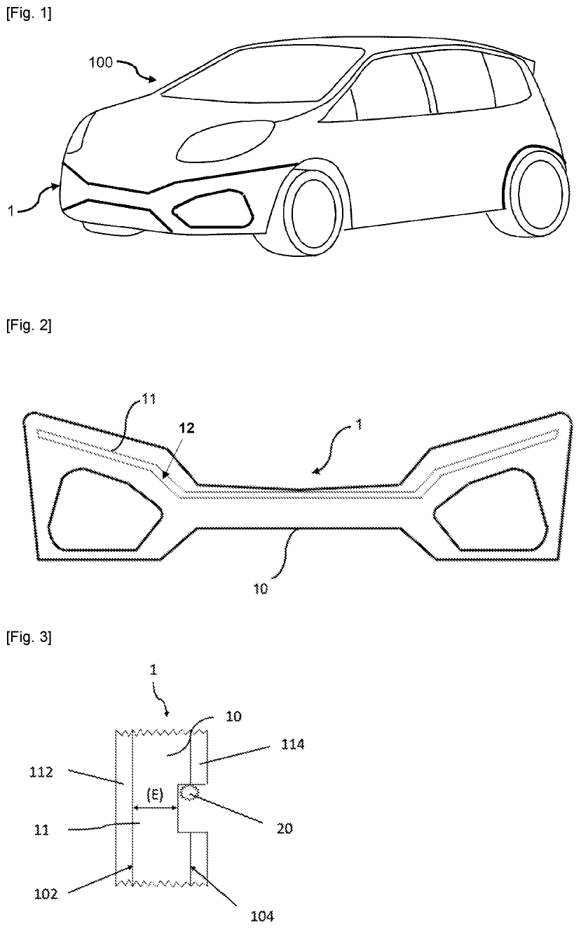

FIG. 1 shows a motor vehicle 100 comprising a bodywork part 1 which is a bumper according to one embodiment of the invention. The bodywork part 1 is made from a plastic material comprising a first zone 10 and a second zone 11 as visible in FIG. 2. In the illustrated example, the second zone 11 has a longitudinal shape which extends over a large part of the length of the bumper.

The bodywork part 1 is manufactured using a single-material plastic injection method which can be chosen from the following list: translucent natural polypropylene, cycloolefin copolymers (COC), polyethylene (PE), polyamide (PA), polycarbonate (PC), blend of polycarbonate (PC), acrylonitrile butadiene styrene (ABS), polystyrene (PS), polymethyl methacrylate (PMMA), thermoplastic polyurethane (TPU) and polyester (PET/PETG).

At the end of the molding, or at the end of subsequent steps in the manufacture of the bodywork part, the first zone 10 has a first thickness and the second zone 11 has a second thickness which is smaller than the first thickness so that the second zone 11 has a better transmittance than that of the first zone 10. According to the aforementioned definitions, the first zone 10 is opaque or semi-opaque while the second zone 11 is transparent or translucent. According to one embodiment, the first thickness is preferably between 2.8 and 3.5 mm.

According to one embodiment, the bodywork part 1 is made of a material of the polypropylene random copolymer type, preferably with an average melt flow rate (MFR) (for example 11 g/10 min at 230° C./2.16 kg). An example of such a polypropylene random copolymer is Moplen RP340N® (Basell Nev., Hoofdorp, the Netherlands), which has an average melt flow rate for use in injection molding applications. Moplen RP340N is nucleated, for improved productivity and very good optical properties (transparency and gloss).

A description of this copolymer can be consulted for example in the following document: https://www.lyondellbasell.com/en/polymers/p/Moplen-RP340N/927a459e-9beb-4eb6-a995-cdb7ec73d5a0.

According to one example of this first embodiment, the first thickness is preferably between 2.8 and 3.5 mm, and the thickness of the second zone 11 is between 0.5 and 2 mm, preferably approximately 1.5 mm. Such a thickness allows the second zone 11, a thinned zone with respect to the first zone, to have a better transmittance, which can reach up to 81% transmittance for a thickness of approximately 1.5 mm.

The method for manufacturing the bodywork part consists in implementing a molding step during which the chosen material is injected into a mold to form the bodywork part 1. The resulting part is then painted. To do this, a masking is first carried out in the second zone 11. For example, a masking film is placed in the second zone 11 and is held by an adhesive. The covered part of the film corresponds to a predefined zone 12 which is intended to be unpainted and transparent. A paint is applied to the bumper 1 before the film is removed from the bumper.

As illustrated in FIG. 2, after painting and removing the film, a painted bumper 1 is obtained, except at the predefined zone 12, which remains transparent.

In an embodiment which is not shown, the second zone 11 is obtained by using an insert in the mold.

In another embodiment, the second zone 11 is obtained by removing material from the bodywork part 1.

In a variant of the embodiment by removal of material, shown in FIG. 3, the material is removed by milling. The figure shows part of the bodywork part 1 seen in section, at the end of the milling step. The part 1 comprises an outer face 102 and an inner face 104. In the example shown in FIG. 3, the outer face 102 is coated with a paint coating 112, and the inner face 104 is coated with a paint coating 114. Thus, in this example, the bodywork part 1 is painted both on its outer face 102 and on its inner face 104. The bodywork part 1 has been cut on its inner face 104 using the cutter 20, which has, by abrasion, removed material. As a result, the second zone 11 has a thickness (E) which is less than the thickness of the part 1 in the first zone 10. In this example, the painting step was prior to the material removal step. Thus, in a simple step of removing material, the second zone 11 and a precise outline of the transparent zone, which is precisely framed by the paint 114 which has remained in place, have been obtained. In a similar variation, the injected material and the paint are removed by laser scraping, rather than milling. In this case, the element 20 is a laser beam.

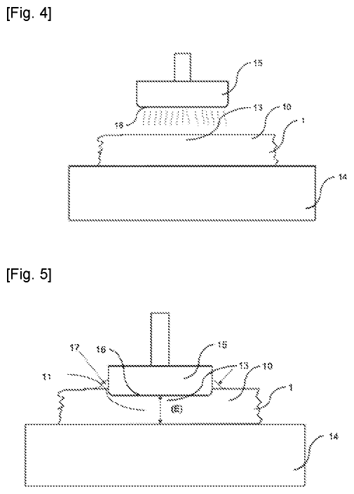

In another variant of the material removal embodiment, shown in FIGS. 4 and 5, a quantity of material is made to creep out of the region 13 intended to form the second zone 11. In the illustrated example, the creep is achieved using a heating means 15, such as a heating punch (which directly emits heat) or an ultrasonic punch (which emits ultrasounds which heat the material). The heating means 15 thus makes it possible to melt a quantity of plastic material from the region 13, and to cause it to creep out of the region 13.

In this example, the following steps are carried out:

The bodywork part 1 is placed on a support 14 as shown in FIG. 4,

A heating means 15 is placed near region 13 intended to form the second zone 11 or in the region 13 intended to form the second zone 11 so as to melt a quantity of material from the region 13.

The molten material 17 is made to creep into the first zone 10 so as to obtain the second thickness (E) of the second zone 11, as shown in FIG. 5.

The heating means 15 in this example consists of an ultrasonic punch having a contact surface 16 intended to come into contact with the region 13 to melt a quantity of material from this region 13 and define the shape of the second zone 11 by the creep of the molten material 17 in the first zone 10. The heating means 15 can also be a heat emitting device.

It will be understood that the second thickness (E) is precisely defined by the distance to be traveled by the heating means 15 and the pressure between the heating means 15 and the support 14. To do this, a control unit can be set up to control the movement of the heating means 15 as a function of the desired second thickness (E).

The invention is not limited to the embodiments described here, and other embodiments will become clearly apparent to a person skilled in the art. In particular, the transparency in the predefined zone 12 can also be obtained by laser scraping in this zone after the bumper has been painted in its entirety.

### LIST OF REFERENCES

1: bodywork part
10: first zone
11: second zone
12: predefined zone
13: region intended to form the second zone
14: support
15: heating medium
16: contact surface
17: molten material
20: cutter or laser beam
100: motor vehicle
102: outer face of the bodywork part
104: inner face of the bodywork part
112: outer paint coating
114: inner paint coating
(E): second thickness

What is claimed is:

1. Bodywork part made of painted plastic material consisting of a single plastic material, and in one piece, and comprising a first zone having a first thickness and a second zone having a second thickness, the first thickness being greater than the second thickness so that the second zone has a higher transmittance than that of the first zone.

2. Bodywork part according to claim 1, wherein the first zone is opaque or semi-opaque and the second zone is transparent or translucent.

3. Bodywork part according to claim 1, wherein the material is chosen from: translucent natural polypropylene, cycloolefin copolymers (COC), polyethylene (PE), polyamide (PA), polycarbonate (PC), acrylonitrile butadiene styrene (ABS), mixture of polycarbonate (PC), polystyrene (PS), polymethyl methacrylate (PMMA), thermoplastic polyurethane (TPU) and polyester (PET/PETG).

4. Bodywork part according to claim 1, wherein the material is a random polypropylene copolymer, such as Moplen RP340N®.

5. Bodywork part according to claim 4, wherein the second zone has a thickness of between 0.5 and 2 mm, preferably a thickness substantially equal to 1.5 mm.

6. Bodywork part according to claim 5, wherein the first zone has a thickness of between 2.8 and 3.5 mm.

7. Motor vehicle comprising at least one bodywork part according to claim 1.

8. Method for manufacturing the bodywork part according to claim 1, comprising a molding step consisting in injecting the material into a mold to form the bodywork part and a step of painting at least on the first zone.

9. Method according to claim 8, comprising the following steps:
masking the second zone;
painting the entire bodywork part;
removing the masking.

10. Method according to claim 8, comprising the following steps:
painting the entire bodywork part;
removing the paint located in the second zone using a laser beam.

11. Method according to claim 8, using an insert in the mold to obtain the second zone.

12. Method according to claim 8, wherein the second zone is obtained by removing material from the bodywork part.

13. Method according to claim 12, wherein the painting step is prior to the material removal step.

14. Method according to claim 12, wherein the material is removed by milling.

15. Method according to claim 12, wherein a quantity of material is made to creep out of the region intended to form the second zone, in order to remove the material.
